(19) United States
(12) Patent Application Publication
(10) Pub. No.: US 2015/0344668 A1
(43) Pub. Date: Dec. 3, 2015

(54) POLYGLYCOLIC ACID RESIN COMPOSITION

(71) Applicant: NISSAN CHEMICAL INDUSTRIES, LTD., Chiyoda-ku, Tokyo (JP)

(72) Inventors: Kazutoshi ODAKA, Funabashi-shi (JP); Takeshi SUWA, Funabshi-shi (JP)

(21) Appl. No.: 14/443,237

(22) PCT Filed: Nov. 14, 2013
(86) PCT No.: PCT/JP2013/080804

§ 371 Date: Jul. 29, 2015

(30) Foreign Application Priority Data
Nov. 16, 2012 (JP) 2012-251829

(51) Int. Cl. C08K 5/20

(52) U.S. Cl. CPC C08K 5/20

(57) ABSTRACT

A poly(glycolic acid) resin composition that contains a crystal nucleator suitable for promoting crystallization of a poly(glycolic acid) resin, has a high crystallization rate in comparison to the poly(glycolic acid) resin, and is capable of having higher molding processability and improving heat resistance. A poly(glycolic acid) resin composition including a poly(glycolic acid) resin and a crystal nucleator composed of a carboxylic acid derivative: B¹-L¹-A-L²-B² [1] {wherein, A is a C₁₋₆ alkylene group optionally having a substituent, or a divalent C₆₋₁₀ aromatic group optionally having a substituent; B¹ and B² are each independently a C₃₋₆ cycloalkyl group optionally having a substituent, or a C₆₋₁₀ aromatic group optionally having a substituent; L¹ and L² are each independently —C(═O)NR¹— (wherein, R¹ is a hydrogen atom or a C₁₋₆ alkyl group) or —C(═O)O—}.

### TECHNICAL FIELD

The present invention relates to a poly(glycolic acid) resin composition, and in particular, to a poly(glycolic acid) resin composition containing a crystal nucleator that is composed of a carboxylic acid derivative, a poly(glycolic acid) resin molded body obtained from the resin composition, and a laminate having a layer of the resin molded body.

### BACKGROUND ART

From the viewpoint of protection of natural environment, an aliphatic polyester capable of being biodegraded in the natural environment has been diligently studied. In particular, since a poly(glycolic acid) resin has biocompatibility, and is excellent in easily hydrolyzable properties, high gas barrier properties, and mechanical properties, the poly(glycolic acid) resin is expected to be used alone or in a combination of another resin as a part such as a sheet, a film, a packing container, a bottle, and a medical suture, or a molding material.

However, the crystallization rate of the poly(glycolic acid) resin is low. Therefore, if the poly(glycolic acid) resin is not sufficiently crystallized, the poly(glycolic acid) resin has a defect in which it is softened at a temperature equal to or higher than a glass transition point (Tg). The crystallinity of the poly(glycolic acid) resin is improved by a heat treatment (annealing) at a predetermined temperature in a mold during injection molding. However, since the crystallization rate is low, the molding cycle performance is low, and the poly(glycolic acid) resin has a problem with productivity. When only the poly(glycolic acid) resin is crystallized, a spherulite having a size equal to or larger than the wavelength of light that causes light scattering grows. Therefore, the appearance (opaque) and the mechanical properties of a molded product may be deteriorated.

In order to solve the problems, a method for adding a crystal nucleator to a poly(glycolic acid) resin is investigated. The crystal nucleator is a primary crystal nucleator of a crystalline polymer, promotes crystal growth, and acts to decrease spherulite size and to promote crystallization.

Hitherto, as a crystal nucleator for the poly(glycolic acid) resin, a carbon filler, talc, kaolin, barium sulfate, and an aromatic carboxylic acid metal salt (Patent Document 1), and graphite, hydroxyapatite, and an amide compound with high melting point (Patent Document 2) have been described.

### PRIOR ART DOCUMENTS

### Patent Documents

Patent Document 1: Japanese Patent Application Publication No. 2008-260902 (JP 2008-260902 A)

Patent Document 2: International Publication WO 2011/024653 Pamphlet

### SUMMARY OF THE INVENTION

### Problem to be Solved by the Invention

As described above, various crystal nucleators for enhancing the crystallization rate of a poly(glycolic acid) resin have been proposed. However, in recent years, a more effective crystal nucleator has been desired to achieve higher molding processability and improvement in heat resistance of the poly(glycolic acid) resin.

Therefore, it is an object of the present invention to provide a poly(glycolic acid) resin composition that contains a crystal nucleator suitable for promoting crystallization of a poly(glycolic acid) resin, has a high crystallization rate in comparison to the poly(glycolic acid) resin, and is capable of having higher molding processability and improving heat resistance, a poly(glycolic acid) resin molded body obtained by crystallizing the poly(glycolic acid) resin composition, and a laminate having a layer of the poly(glycolic acid) resin molded body.

### Means for Solving the Problem

The present inventors have intensively investigated to achieve the object, and as a result, found that crystallization of a poly(glycolic acid) resin can be promoted by adding a specific carboxylic acid derivative as a crystal nucleator to a poly(glycolic acid) resin.

Specifically, as a first aspect, the present invention relates to a poly(glycolic acid) resin composition comprising a poly(glycolic acid) resin and a crystal nucleator that is composed of a carboxylic acid derivative of Formula [1]:

B′-L′-A-L²-B² [1]

{wherein, A is a C₁₋₆ alkylene group optionally having a substituent, or a divalent C₆₋₁₀ aromatic group optionally having a substituent; B¹ and B² are each independently a C₃₋₆ cycloalkyl group optionally having a substituent, or a C₆₋₁₀ aromatic group optionally having a substituent; L¹ and L² are each independently —C(═O)NR¹— (wherein, R¹ is a hydrogen atom or a C₁₋₆ alkyl group) or —C(═O)O—}.

As a second aspect, the present invention relates to the poly(glycolic acid) resin composition according to the first aspect, wherein at least one of L′ and L² is —C(═O)NR¹— (wherein, R¹ is the same as defined above).

As a third aspect, the present invention relates to the poly(glycolic acid) resin composition according to the first aspect, wherein L¹ and L² are —C(═O)NR¹— (wherein, R¹ is the same as defined above).

As a fourth aspect, the present invention relates to the poly(glycolic acid) resin composition according to any one of the first to third aspects, wherein A is a divalent organic group of Formula [2] or [3]:

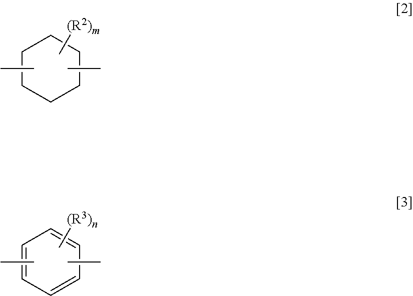

{wherein, R² and R³ are each independently a C₁₋₆ alkyl group, a C₂₋₇ acyl group, a C₂₋₇ alkoxycarbonyl group, an amino group, a C₁₋₆ acylamino group, a hydroxy group, or a C₁₋₆ alkoxy group; m is an integer of 0 to 10 (when m is 2 or more, R²s may be the same or different from each other), n is an integer of 0 to 4 (when n is 2 or more, R³s may be the same or different from each other)}.

As a fifth aspect, the present invention relates to the poly(glycolic acid) resin composition according to the fourth aspect, wherein A is a cyclohexane-1,4-diyl group.

As a sixth aspect, the present invention relates to the poly(glycolic acid) resin composition according to the fourth aspect, wherein A is a p-phenylene group.

As a seventh aspect, the present invention relates to the poly(glycolic acid) resin composition according to any one of the first to sixth aspects, wherein B¹ and B² are a monovalent organic group of Formula [4] or [5]:

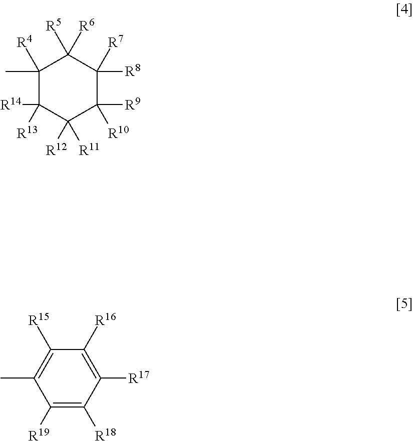

(wherein, R⁴ to R¹⁹ are each independently a hydrogen atom, a C₁₋₆ alkyl group, a C₂₋₇ acyl group, a C₂₋₇ alkoxycarbonyl group, an amino group, a C₁₋₆ acylamino group, a hydroxy group, or a C₁₋₆ alkoxy group).

As an eighth aspect, the present invention relates to the poly(glycolic acid) resin composition according to the seventh aspect, wherein B¹ and B² are a cyclohexyl group or a monovalent organic group of Formula [6]:

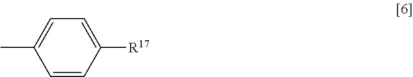

(wherein, R¹⁷ is the same as defined above).

As a ninth aspect, the present invention relates to the poly(glycolic acid) resin composition according to any one of the first to eighth aspects, wherein the content of the crystal nucleator is 0.001 to 10 parts by mass relative to 100 parts by mass of the poly(glycolic acid) resin.

As a tenth aspect, the present invention relates to a poly(glycolic acid) resin molded body obtained by crystallizing the poly(glycolic acid) resin composition according to any one of the first to ninth aspects.

As an eleventh aspect, the present invention relates to a laminate having a layer of the poly(glycolic acid) resin molded body according to the tenth aspect.

### Effects of the Invention

In a poly(glycolic acid) resin composition of the present invention, a crystallization promoting effect of a poly(glycolic acid) resin is improved using a specific carboxylic acid derivative as a crystal nucleator. Therefore, a poly(glycolic acid) resin composition having excellent molding processability and heat resistance, a poly(glycolic acid) resin molded body obtained by crystallizing the poly(glycolic acid) resin composition, and a laminate having a layer of the poly(glycolic acid) resin molded body can be provided.

### MODES FOR CARRYING OUT THE INVENTION

Hereinafter, the present invention will be described in detail.

<Poly(Glycolic Acid) Resin Composition>

The poly(glycolic acid) (hereinafter also referred to as PGA) resin composition of the present invention contains a PGA resin and a crystal nucleator composed of a carboxylic acid derivative.

[PGA Resin]

Examples of a PGA resin used in the present invention may include a homopolymer of glycolic acid including only glycolic acid repeating unit of Formula [7]:

—[O—CH₂—C(═O)]— [7]

(hereinafter also referred to as PGA homopolymer, and contains a ring-opening polymer of glycolide as a bimolecular cyclic ester of glycolic acid), and a poly(glycolic acid) copolymer containing the glycolic acid repeating unit (hereinafter also referred to as PGA copolymer). One kind of the PGA resin may be used alone, or two or more kinds thereof may be used in combination.

When the PGA copolymer is produced, examples of a comonomer used with a glycolic acid monomer may include lactides such as dilactide (another name: 1,4-dioxan-2,5-dione); lactones such as β-propiolactone, β-butyrolactone, β-pivalolactone, γ-butyrolactone, δ-valerolactone, β-methyl-δ-valerolactone, and ε-caprolactone; cyclic carbonates such as trimethylene carbonate (another name: 1,3-dioxan-2-one); cyclic esters such as ethylene oxalate (another name: 1,4-dioxan-2,3-dione); cyclic ether esters such as 1,4-dioxan-2-one; cyclic ethers such as 1,3-dioxane; cyclic amides such as ε-caprolactam; hydroxycarboxylic acids such as lactic acid, 3-hydroxypropanoic acid, 3-hydroxybutanoic acid, 4-hydroxybutanoic acid, 6-hydroxycaproic acid, or an alkyl ester thereof; and a mixture of substantially equimolar amounts of an aliphatic diol such as ethylene glycol and 1,4-butane diol and an aliphatic dicarboxylic acid such as succinic acid and adipic acid or an alkyl ester thereof. One kind of the comonomer may be used alone, or two or more kinds thereof may be used in combination. Among the comonomers, hydroxycarboxylic acids are preferred in terms of heat resistance.

Examples of a catalyst used for production of the PGA resin by ring-opening polymerization of glycolide may include a known ring-opening polymerization catalyst including a tin compound such as halogenated tin and organic tin carboxylate; a titanium compound such as alkoxy titanate; an aluminum compound such as alkoxy aluminum; a zirconium compound such as zirconium acetylacetone; and an antimony compound such as halogenated antimony and antimony oxide.

The PGA resin can be produced by a conventionally known polymerization method, and the polymerization temperature is preferably 120 to 300° C., more preferably 130 to 250° C., particularly preferably 140 to 240° C., and most preferably 150 to 230° C. When the polymerization temperature is 120° C. or higher, polymerization can sufficiently proceed. When it is 300° C. or lower, thermal decomposition of a produced resin can be suppressed.

The polymerization time of the PGA resin is preferably 2 minutes to 50 hours, more preferably 3 minutes to 30 hours, and particularly preferably 5 minutes to 20 hours. When the polymerization time is 2 minutes or more, polymerization can sufficiently proceed. When it is 50 hours or less, an uncolored resin can be obtained.

In the PGA resin used in the present invention, the content of the glycolic acid repeating unit of Formula [7] is preferably 70% by mass or more, more preferably 80% by mass or more, further preferably 90% by mass or more, and particularly preferably 100% by mass. When the content of the glycolic acid repeating unit is 70% by mass or more, effects of the PGA resin such as biodegradability, hydrolyzability, gas barrier properties, mechanical strength, and heat resistance can be further obtained.

The weight-average molecular weight Mw of the PGA resin is preferably 30,000 to 800,000, and more preferably 50,000 to 500,000. When the weight-average molecular weight Mw is 30,000 or more, a PGA resin molded body can obtain sufficient mechanical strength. When the weight-average molecular weight Mw is 800,000 or less, the PGA resin can be easily melt-extruded or injection-molded. The weight-average molecular weight Mw is a value measured by gel permeation chromatography (GPC) in terms of poly(methyl methacrylate).

The melt viscosity (temperature: 270° C., shear rate: 122 sec⁻¹) of the PGA resin is preferably 50 to 3,000 Pa·s, more preferably 100 to 2,000 Pa·s, and further preferably 100 to 1,000 Pa·s. When the melt viscosity is 50 Pa·s or more, a PGA resin molded body has sufficient mechanical strength. When the melt viscosity is 3,000 Pa·s or less, the PGA resin can be easily melt-extruded or injection-molded.

The PGA resin used in the present invention may be a blended polymer with another resin mainly containing a PGA homopolymer or a PGA copolymer. Examples of the other resin may include a biodegradable resin other than a PGA resin as described below, a general-purpose thermoplastic resin, and a general-purpose thermoplastic engineering plastic.

Examples of the biodegradable resin other than a PGA resin may include poly(hydroxyalkanoic acid) such as poly(lactic acid) (PLA), poly(3-hydroxybutyric acid) (PHB), and a copolymer of 3-hydroxybutyric acid and 3-hydroxyhexanoic acid (PHBH); a polyester resin such as polycaprolactone, poly(butylene succinate), poly(butylene succinate/adipate), poly(butylene succinate/carbonate), poly(ethylene succinate), and poly(ethylene succinate/adipate); poly(vinyl alcohol); modified starch; cellulose acetate; chitin; chitosan; and lignin.

Examples of the general-purpose thermoplastic resin may include a polyolefin resin such as polyethylene (PE), a polyethylene copolymer, polypropylene (PP), a polypropylene copolymer, polybutylene (PB), an ethylene-vinyl acetate copolymer (EVA), an ethylene-ethyl acrylate copolymer (EEA), and poly(4-methyl-1-pentene); a polystyrene-based resin such as polystyrene (PS), high-impact polystyrene (HIPS), an acrylonitrile-styrene copolymer (AS), and an acrylonitrile-butadiene-styrene copolymer (ABS); a poly(vinyl chloride) resin; a polyurethane resin; a phenolic resin; an epoxy resin; an amino resin; and an unsaturated polyester resin.

Example of the general-purpose engineering plastic may include a polyamide resin; a polyimide resin; a polycarbonate resin; a poly(phenylene ether) resin; a modified poly(phenylene ether) resin; a polyester resin such as poly(ethylene terephthalate) (PET) and poly(butylene terephthalate) (PBT); a polyacetal resin; a polysulfone resin; and a poly(phenylene sulfide) resin.

[Crystal Nucleator Composed of Carboxylic Acid Derivative]

The crystal nucleator used in the present invention is composed of a carboxylic acid derivative of Formula [1]:

B¹-L¹-A-L²-B² [1].

In Formula [1], L¹ and L² are each independently —C(═O)NR¹— (wherein, R¹ is a hydrogen atom or a C₁₋₆ alkyl group, and preferably a hydrogen atom) or —C(═O)O—, and it is preferable that at least one of L¹ and L² be —C(═O)NR¹—, and it is more preferable that both L¹ and L² be —C(═O)NR¹—.

Examples of the C₁₋₆ alkyl group of R¹ may include a methyl group, an ethyl group, an n-propyl group, an isopropyl group, an n-butyl group, an isobutyl group, a sec-butyl group, a tert-butyl group, an n-pentyl group, an isopentyl group, a neopentyl group, an n-hexyl group, and a cyclohexyl group.

Moieties of —C(═O)NR¹— and —C(═O)O— that are bonded to A may be a C(═O) moiety, or a NR¹ moiety and an O moiety. Specifically, when L¹ is —C(═O)NR′—, the carboxylic acid derivative in the present invention contains both B¹—C(═O)NR¹-A-L²-B² and B¹-NR¹C(═O)-A-L²-B². When L¹ is —C(═O)O—, the carboxylic acid derivative in the present invention contains both B¹—C(═O)O-A-L²-B² and B′-OC(═O)-A-L²-B².

In Formula [1], A is a C₁₋₆ alkylene group optionally having a substituent, or a divalent C₆₋₁₀ aromatic group optionally having a substituent. A is preferably a divalent organic group of Formula [2] or [3], and more preferably a cyclohexane-1,4-diyl group or a p-phenylene group.

Examples of the C₁₋₆ alkylene group of A may include a linear or branched alkylene group such as a methylene group, an ethylene group, a trimethylene group, a methylethylene group, a tetramethylene group, a 1-methyltrimethylene group, a pentamethylene group, a 2,2-dimethyltrimethylene group, and a hexamethylene group; and a cyclic alkylene group such as a cyclopropane-1,2-diyl group, a cyclobutane-1,2-diyl group, a cyclobutane-1,3-diyl group, a cyclopentane-1,2-diyl group, a cyclopentane-1,3-diyl group, a cyclohexane-1,2-diyl group, a cyclohexane-1,3-diyl group, and a cyclohexane-1,4-diyl group. Among these, a cyclic alkylene group is preferred.

Examples of the divalent C₆₋₁₀ aliphatic group of A may include a phenylene group such as an o-phenylene group, a m-phenylene group, and a p-phenylene group; and a naphthalenediyl group such as a naphthalene-1,4-diyl group, a naphthalene-1,5-diyl group, and a naphthalene-2,6-diyl group. Among these, a phenylene group is preferred.

Examples of a substituent that may be included in the C₁₋₆ alkylene group and the divalent C₆₋₁₀ aromatic group may include a C₁₋₆ alkyl group, a C₂₋₇ acyl group, a C₂₋₇ alkoxycarbonyl group, an amino group, a C₁₋₆ acylamino group, a hydroxy group, and a alkoxy group. Specific examples thereof may include the same groups as groups exemplified with respect to R² and R³ described below.

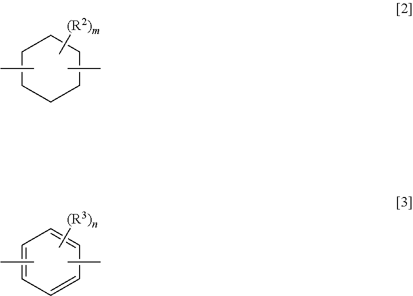

In Formulae [2] and [3], R² and R³ are each independently a C₁₋₆ alkyl group, a C₂₋₇ acyl group, a C₂₋₇ alkoxycarbonyl group, an amino group, a C₁₋₆ acylamino group, a hydroxy group, or a C₁₋₆ alkoxy group.

Examples of the C₁₋₆ alkyl group of R² and R³ may include the same groups as the groups exemplified with respect to R¹.

Examples of the C₂₋₇ acyl group of R² and R³ may include a group in which a C₁₋₆ alkyl group is bonded to a carbonyl group, for example, an acetyl group, a propionyl group, a butyryl group, an isobutyryl group, a pentanoyl group, a 2-methylbutanoyl group, a 3-methylbutanoyl group, a pivaloyl group, an n-hexanoyl group, a 4-methylpentanoyl group, a 3,3-dimethylbutanoyl group, a heptanoyl group, and a cyclohexanecarbonyl group.

Examples of the C₂₋₇ alkoxycarbonyl group of R² and R³ may include a group in which a C₁₋₆ alkoxy group is bonded to a carbonyl group, for example, a methoxycarbonyl group, an ethoxycarbonyl group, an n-propoxycarbonyl group, an isopropoxycarbonyl group, an n-butoxycarbonyl group, an isobutoxycarbonyl group, a sec-butoxycarbonyl group, a tert-butoxycarbonyl group, an n-pentyloxycarbonyl group, an isopentyloxycarbonyl group, a neopentyloxycarbonyl group, an n-hexyloxycarbonyl group, and a cyclohexyloxycarbonyl group.

Examples of the C₁₋₆ acyamino group of R² and R³ may include an acetamido group, a propionamido group, a butyramido group, an isobutyramido group, a pentaneamido group, a 2-methylbutaneamido group, a 3-methylbutaneamido group, a pivalamido group, an n-hexaneamido group, a 4-methylpentaneamido group, a 3,3-dimethylbutaneamido group, a heptaneamido group, and a cyclohexanecarboxamido group.

Examples of the C₁₋₆ alkoxy group of R² and R³ may include a methoxy group, an ethoxy group, an n-propoxy group, an isopropoxy group, an n-butoxy group, an isobutoxy group, a sec-butoxy group, a tert-butoxy group, an n-pentyloxy group, an isopentyloxy group, a neopentyloxy group, an n-hexyloxy group, and a cyclohexyloxy group.

In Formula [2], m is an integer of 0 to 10, and preferably 0. When m is 2 or more, R²s may be the same or different from each other.

In Formula [3], n is an integer of 0 to 4, and preferably 0. When n is 2 or more, R³s may be the same or different from each other.

In Formula [1], B¹ and B² are each independently a C₃₋₆ cycloalkyl group optionally having a substituent, or a C₆₋₁₀ aromatic group optionally having a substituent, preferably a monovalent organic group of Formula [4] or [5], and more preferably a cyclohexyl group or a group of Formula [6], and particularly preferably a 4-acetylphenyl group wherein R¹⁷ is an acetyl group.

Examples of the C₃₋₆ cycloalkyl group of B¹ and B² may include a cyclopropyl group, a cyclobutyl group, a cyclopentyl group, and a cyclohexyl group.

Examples of the C₆₋₁₀ aromatic group of B¹ and B² may include a phenyl group and a naphthyl group.

Examples of a substituent that may be included in the C₃₋₆ cycloalkyl group and the C₆₋₁₀ aromatic group may include a C₁₋₆ alkyl group, a C₂₋₇ acyl group, a C₂₋₇ alkoxycarbonyl group, an amino group, a C₁₋₆ acylamino group, a hydroxy group, and a C₁₋₆ alkoxy group. Specific examples thereof may include the same groups as the groups exemplified with respect to R² and R³ described above.

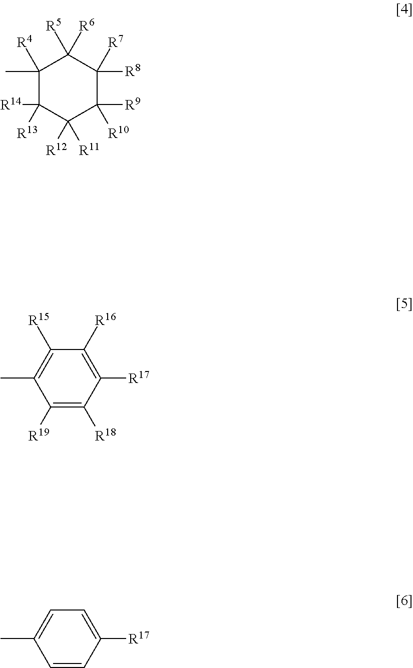

In Formulae [4] to [6], R⁴ to R¹⁹ are each independently a hydrogen atom, a C₁₋₆ alkyl group, a C₂₋₇ acyl group, a C₂₋₇ alkoxycarbonyl group, an amino group, a C₁₋₆ acylamino group, a hydroxy group, or a C₁₋₆ alkoxy group.

Examples of the C₁₋₆ alkyl group, the C₂₋₇ acyl group, the C₂₋₇ alkoxycarbonyl group, the C₁₋₆ acylamino group, and the C₁₋₆ alkoxy group of R⁴ to R¹⁹ may include the same groups as the groups exemplified with respect to R² and R³.

Examples of B¹ and B² may include a cyclohexyl group, a methylcyclohexyl group, a tert-butylcyclohexyl group, an acetylcyclohexyl group, a methoxycarbonylcyclohexyl group, an ethoxycarbonylcyclohexyl group, an aminocyclohexyl group, an acetamidecyclohexyl group, a hydroxycyclohexyl group, a methoxycyclohexyl group, an ethoxycyclohexyl group, a tert-butoxycyclohexyl group, a phenyl group, a tolyl group, a dimethylphenyl group, a tert-butylphenyl group, an acetylphenyl group, a propyonylphenyl group, a methoxycarbonylphenyl group, an ethoxycarbonylphenyl group, an aminophenyl group, an acetamidephenyl group, a propionamidephenyl group, a hydroxyphenyl group, a methoxyphenyl group, an ethoxyphenyl group, and a tert-butoxyphenyl group.

A method for producing the carboxylic acid derivative of Formula [1] is not particularly limited. The carboxylic acid derivative can be easily obtained by amidation or esterification of carboxylic acid or an activator thereof (acid halide, acid anhydride, acid azide, active ester, etc.) with amine or alcohol through a conventionally known method.

Specifically, when L¹ and L² are —C(═O)NR¹—, that is, a carboxylic acid derivative to produce an amide linkage, examples of the method may include methods shown in Formulae [8] and [9].

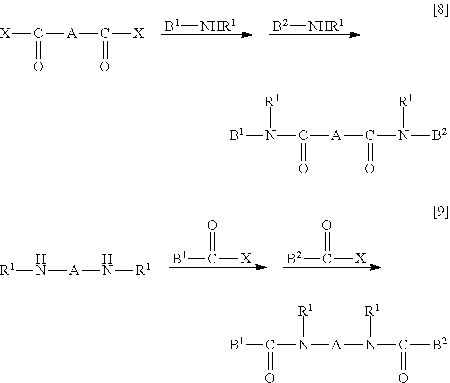

In Formulae [8] and [9], A, B¹, B², and R¹ are the same as defined above. X is not particularly limited as long as it is a group capable of producing an amide linkage. Examples thereof may include a hydroxy group; an alkoxy group such as a methoxy group and an ethoxy group; a halogen atom such as a chlorine atom and a bromine atom; an acyloxy group such as an acetoxy group; an azido group; and a 2,5-dioxopyrrolidin-1-yloxy group. When B¹ and B² are different groups, one compound may be first allowed to react, followed by a reaction with the other compound, or both the compounds may be allowed to react simultaneously.

For example, when L¹ and L² are that is, a carboxylic acid derivative to produce an ester linkage, examples of the method may include methods shown in Formulae [10] and [11].

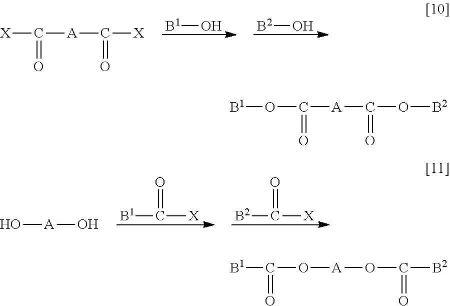

In Formulae [10] and [11], A, B¹, and B² are the same as defined above. X is not particularly limited as long as it is a group capable of producing an ester linkage. Examples thereof may include a hydroxy group; an alkoxy group such as a methoxy group and an ethoxy group; a halogen atom such as a chlorine atom and a bromine atom; an acyloxy group such as an acetoxy group; an azido group; and a 2,5-dioxopyrrolidin-1-yloxy group. When B¹ and B² are different groups, one compound may be first allowed to react, followed by a reaction with the other compound, or both the compounds may be allowed to react simultaneously.

Similarly, a carboxylic acid derivative in which L₁ and L² are different from each other can be also obtained.

When the carboxylic acid derivative of Formula [1] is commercially available, a commercially available product can be also used.

### [Other Additive]

A known inorganic filler may be mixed in the PGA resin composition of the present invention as long as the effects of the present invention are not impaired. Examples of the inorganic filler may include glass fibers, carbon fibers, talc, mica, silica, kaolin, clay, wollastonite, glass beads, glass flakes, potassium titanate, calcium carbonate, magnesium sulfate, and titanium oxide. The shape of the inorganic filler may be any of a fiber shape, a granular shape, a plate shape, a needle shape, a spherical shape, and a powder shape. The inorganic filler may be used in an amount of 300 parts by mass or less relative to 100 parts by mass of the PGA resin.

A known flame retardant may be mixed in the PGA resin composition of the present invention as long as the effects of the present invention are not impaired. Examples of the flame retardant may include a halogen-containing flame retardant such as a bromine-containing flame retardant and a chlorine-containing flame retardant; an antimony-containing flame retardant such as antimony trioxide and antimony pentoxide; an inorganic flame retardant such as aluminum hydroxide, magnesium hydroxide, and a silicone-based compound; a phosphorous-containing flame retardant such as red phosphorous, phosphate esters, ammonium polyphosphate, and phosphazene; a melamine-based flame retardant such as melamine, melam, melem, melon, melamine cyanurate, melamine phosphate, melamine pyrophosphate, melamine polyphosphate, a melamine-melam-melem polyphosphate double salt, melamine alkylphosphate, melamine phenylphosphate, melamine sulfate, and melam methanesulfonate; and a fluororesin such as PTFE. The flame retardant may be used in an amount of 200 parts by mass or less relative to 100 parts by mass of the PGA resin.

An additive to be generally added if necessary may be appropriately mixed in the PGA resin composition of the present invention as long as the effects of the present invention are not impaired. Examples thereof may include an end-capping agent, a hydrolysis inhibitor, a thermal stabilizer, a photostabilizer, a heat ray absorbent, a ultraviolet absorber, an antioxidant, a impact modifier, a plasticizer, a compatibilizer, various types of coupling agents such as silane series, titanium series, and aluminum series coupling agents, an foaming agent, an antistatic agent, a release agent, a lubricant, an antibacterial antifungal agent, a pigment, a dye, a flavor, various other fillers, other crystal nucleators, and other thermoplastic resins.

[Method for Producing Poly(Glycolic Acid) Resin Composition]

The PGA resin composition of the present invention can be produced by mixing the PGA resin and the crystal nucleator composed of a carboxylic acid derivative. A method of mixing the crystal nucleator is not particularly limited, and examples thereof may include a method of mixing the crystal nucleator into a composition containing the PGA resin or the PGA resin and the other additive before molding; and a method of mixing the crystal nucleator in a composition containing the PGA resin or the PGA resin and the other additive during molding (e.g., side feed method). Further, the PGA resin composition can be produced by mixing the crystal nucleator in a monomer of glycolic acid or the like during synthesis of the PGA resin.

The PGA resin composition of the present invention is preferably a PGA resin composition having a cooling crystallization temperature (a temperature at which a resin is crystallized during cooling of a resin composition in a molten state) Tcc of 145° C. or higher, more preferably 160° C. or higher, and particularly preferably 170° C. or higher.

<Poly(Glycolic Acid) Resin Molded Body>

A PGA resin molded body of the present invention is constructed by containing the crystallized PGA resin and the crystal nucleator composed of a carboxylic acid derivative. Further, the spherulite diameter of the PGA resin molded body of the present invention is preferably 30 μm or less, and more preferably 20 μm or less. When the spherulite diameter is 30 μm or less, a PGA resin molded body having a smoother surface can be obtained.

Such a PGA resin molded body can be obtained, for example, from the PGA resin composition of the present invention by crystallizing a PGA resin contained in the PGA resin composition. A method of crystallizing the PGA resin is not particularly limited, and for example, the PGA resin composition may be heated at a temperature that is equal to or higher than the crystallization temperature, followed by cooling, during a process of molding the PGA resin composition into a predetermined shape. Alternatively, in the process, the PGA resin composition is heated at a temperature that is equal to or higher than the melting point, followed by quenching, to obtain a molded body in an amorphous form as it is, and the molded body is further heated to be crystalized. Thus, the molded body can be crystallized.

Since the spherulite diameter of the PGA resin molded body of the present invention is small and the same, the PGA resin molded body has excellent gas barrier properties, mechanical strength, and heat resistance.

In molding of the PGA resin composition of the present invention, various molded products can be easily produced through a commonly used molding method of general injection molding, blow molding, vacuum molding, compression molding, or the like.

Use of the PGA resin for a carbonated drink bottle or the like utilizing the properties (high gas barrier properties) thereof is proposed. A typical method of molding such bottle is injection blow molding.

In injection blow molding, the PGA resin composition is injection molded into a closed-end parison (preform) in a test tube shape, the parison is then blow molded in a supercooled state or at a temperature equal to or higher than a glass transition point. Specifically, the injection blow molding is classified into two molding methods (hot parison method and cold parison method).

In the hot parison method, after injection molding into the parison, the parison is blow molded while the temperature is adjusted to a temperature equal to or lower than the melting point so as not to be solidified. In this case, the bottle is crystallized when the resin is cooled from a molten state. As crystallization occurs at higher temperature, the crystallization rate of the resin is higher. This shows that the performance of the crystal nucleator is high. In DSC measurement, the cooling crystallization temperature Tcc is used as an index.

In the cold parison method, after injection molding into the parison, the parison is cooled and solidified once, reheated at a temperature equal to or higher than the glass transition point to adjust the temperature, and blow molded. In this case, the bottle is crystallized when the resin is heated at a temperature equal to or higher than the glass transition point. As crystallization occurs at lower temperature, the crystallization rate of the resin is higher. This shows that the performance of the crystal nucleator is excellent. In DSC measurement, the heating crystallization temperature (a temperature at which a resin is crystallized during heating of a resin composition in an amorphous state at a temperature lower than the glass transition point) Tch is used as an index.

The PGA resin composition of the present invention can be suitably molded even by either of the injection blow molding methods.

<Laminate>

A laminate of the present invention has a layer of the PGA resin molded body of the present invention, has two or more layers, and is not particularly limited as long as it has the layer of the PGA resin molded body and another layer adjacent to the layer. Examples of the other layer adjacent to the layer of the PGA resin molded body may include a layer of a thermoplastic resin, a layer of paper, and a layer of an adhesive.

Examples of the thermoplastic resin may include a polyester resin such as poly(ethylene terephthalate) (PET), poly(butylene terephthalate) (PBT), poly(ethylene naphthalate) (PEN), poly(butylene naphthalate) (PBN), poly(butylene succinate), poly(ethylene succinate/adipate), poly(lactic acid) (PLA), poly(3-hydroxybutyrate), and polycaprolactone; a polyolefine resin such as polyethylene (PE), polypropylene (PP), an ethylene-propylene copolymer, an ethylene-vinyl alcohol copolymer (EVOH), an ethylene-vinyl acetate copolymer (EVA), and an ethylene-ethyl acrylate copolymer (EEA); a polystyrenic resin such as polystyrene (PS), a styrene-butadiene copolymer, an acrylonitrile-butadiene-styrene copolymer (ABS), and a methyl methacrylate-styrene copolymer (MS); a polycarbonate resin; a poly(vinyl chloride) resin; a poly(vinylidene chloride) resin; a polyamide resin such as 6-nylon and 6,6-nylon; a polyimide resin; a (meth)acrylic resin such as a poly(methyl methacrylate) (PMMA); a sulfide resin such as a poly(phenylene sulfide) resin; and a polyurethane resin. One kind of the thermoplastic resin may be used alone, or two or more kinds thereof may be used in combination.

Among these, since a laminate that satisfies both desired transparency and gas barrier properties according to an application is obtained, the polyester resin is preferred, an aromatic polyester resin in which at least one of a diol component and a dicarboxylic acid component is an aromatic compound is more preferred, and an aromatic polyester resin obtained from an aromatic dicarboxylic acid is particularly preferred.

In such a laminate, the constitution ratio of the layer of the PGA resin molded body is preferably 1 to 10% in terms of mass (that is nearly equal to thickness standard). When the constitution ratio of the layer of the PGA resin molded body is 1% by mass or more, sufficient gas barrier properties of the laminate can be achieved. When it is 10% or less, a large amount of stress is not necessary during blow molding, and the transparency of the laminate can be maintained.

Specific examples of forms of the laminate of the present invention may include a multilayer film, a multilayer sheet, and a molding container such as a multilayer hollow container. Examples of such a laminate may include a product molded by co-extrusion molding or co-injection molding, and a product stretch-molded by co-extrusion blow molding or co-injection blow molding.

### EXAMPLES

Hereinafter, the present invention will be described specifically with reference to Examples, but the present invention is not limited to the following Examples. In Examples, apparatuses and conditions used for analysis of physical properties of samples are as follows.

(1) Measurement of 5% weight loss temperature (Td₅%) and melting point

Apparatus: Thermo plus TG8120 manufactured by Rigaku Corporation
Measurement conditions: in an air atmosphere
Temperature increasing rate: 10° C./min (25 to 500° C.)

(2) Measurement of differential scanning calorimetry (DSC)

Apparatus: Diamond DSC manufactured by PerkinElmer Japan Co., Ltd.

### Synthesis Example 1

### Production of N¹,N⁴-diphenylterephthalamide

1.01 g (11 mmol) of aniline (manufactured by Tokyo Chemical Industry Co., Ltd.), 1.00 g (9.9 mmol) of triethylamine (manufactured by Tokyo Chemical Industry Co., Ltd.), and 18.1 g of N,N-dimethylacetamide (9 times the total mass of aniline and triethylamine) were placed in a reaction flask equipped with a stirrer, a thermometer, a dropping funnel, and a condenser, and cooled in an ice bath with stirring. To this solution, a solution in which 1.00 g (4.9 mmol) of terephthaloyl chloride (manufactured by Tokyo Chemical Industry Co., Ltd.) was dissolved in 9.0 g of N,N-dimethylacetamide (9 times the mass of terephthaloyl chloride) was slowly added dropwise, and the mixture was stirred for 3 hours. The reaction mixture was added dropwise to 210 g of mixed solution of water and methanol (mass ratio 7:3) (7.5 times the total mass of used N,N-dimethylacetamide), to precipitate a product in a slurry state. The obtained slurry was filtrated under reduced pressure, washed with a mixed solution of water and methanol (mass ratio 7:3), and dried to obtain a target compound (compound A) in a white powder form.

The 5% weight loss temperature (Td₅%) of the obtained target compound was 285.8° C., and the melting point was 346.5° C.

### Synthesis Example 2

### Production of N¹,N⁴-di-p-tolylterephthalamide

A target compound (compound B) in a white powder form was obtained by the same operation as in Synthesis Example 1 except that aniline was changed to 1.16 g (11 mmol) of 4-methylaniline (manufactured by Tokyo Chemical Industry Co., Ltd.).

The 5% weight loss temperature (Td₅%) of the obtained target compound was 349.1° C., and the melting point was 353.7° C.

### Synthesis Example 3

### Production of N¹,N⁴-bis(4-tert-butylphenyl)terephthalamide

A target compound (compound C) in a white powder form was obtained by the same operation as in Synthesis Example 1 except that aniline was changed to 1.62 g (11 mmol) of 4-tert-butylaniline (manufactured by Tokyo Chemical Industry Co., Ltd.).

The 5% weight loss temperature (Td₅%) of the obtained target compound was 354.6° C., and the melting point was 304.4° C.

### Synthesis Example 4

### Production of N¹,N⁴-bis(2-acetylphenyl)terephthalamide

A target compound (compound D) in a white powder form was obtained by the same operation as in Synthesis Example 1 except that aniline was changed to 1.47 g (11 mmol) of 2-aminoacetophenone (manufactured by Tokyo Chemical Industry Co., Ltd.).

The 5% weight loss temperature (Td₅%) of the obtained target compound was 261.3° C., and the melting point was 313.1° C.

### Synthesis Example 5

### Production of N¹,N⁴-bis(3-acetylphenyl)terephthalamide

A target compound (compound E) in a white powder form was obtained by the same operation as in Synthesis Example 1 except that aniline was changed to 1.47 g (11 mmol) of 3-aminoacetophenone (manufactured by Tokyo Chemical Industry Co., Ltd.).

The 5% weight loss temperature (Td₅%) of the obtained target compound was 359.7° C., and the melting point was 310.0° C.

### Synthesis Example 6

### Production of N¹,N⁴-bis(4-acetylphenyl)terephthalamide

A target compound (compound F) in a white powder form was obtained by the same operation as in Synthesis Example 1 except that aniline was changed to 1.47 g (11 mmol) of 4-aminoacetophenone (manufactured by Tokyo Chemical Industry Co., Ltd.).

The 5% weight loss temperature (Td₅%) of the obtained target compound was 337.6° C., and the melting point was 364.0° C.

### Synthesis Example 7

### Production of N¹,N⁴-bis(4-acetamidophenyl)terephthalamide

A target compound (compound G) in a white powder form was obtained by the same operation as in Synthesis Example 1 except that aniline was changed to 1.63 g (11 mmol) of 4-aminoacetoanilide (manufactured by Tokyo Chemical Industry Co., Ltd.).

The 5% weight loss temperature (Td₅%) of the obtained target compound was 442.9° C., and the melting point was not observed.

### Synthesis Example 8

### Production of N¹,N⁴-bis(4-hydroxyphenyl)terephthalamide

A target compound (compound H) in a white powder form was obtained by the same operation as in Synthesis Example 1 except that aniline was changed to 1.18 g (11 mmol) of 4-aminophenol (manufactured by Tokyo Chemical Industry Co., Ltd.).

The 5% weight loss temperature (Td₅%) of the obtained target compound was 390.3° C., and the melting point was 399.4° C.

### Synthesis Example 9

### Production of N¹,N⁴-bis(4-methoxyphenyl)terephthalamide

A target compound (compound I) in a white powder form was obtained by the same operation as in Synthesis Example 1 except that aniline was changed to 1.34 g (11 mmol) of 4-methoxyaniline (manufactured by Tokyo Chemical Industry Co., Ltd.).

The 5% weight loss temperature (Td₅%) of the obtained target compound was 353.0° C., and the melting point was 351.3° C.

### Synthesis Example 10

### Production of N¹,N⁴-dicyclohexylterephthalamide

A target compound (compound J) in a white powder form was obtained by the same operation as in Synthesis Example 1 except that aniline was changed to 1.08 g (11 mmol) of cyclohexylamine (manufactured by Tokyo Chemical Industry Co., Ltd.).

The 5% weight loss temperature (Td₅%) of the obtained target compound was 303.6° C., and the melting point was 345.1° C.

### Synthesis Example 11

### Production of N¹,N³-bis(4-acetylphenyl)isophthalamide

A target compound (compound K) in a white powder form was obtained by the same operation as in Synthesis Example 1 except that aniline was changed to 1.47 g (11 mmol) of 4-aminoacetophenone (manufactured by Tokyo Chemical Industry Co., Ltd.) and terephthaloyl chloride was changed to 1.00 g (4.9 mmol) of isophthaloyl chloride (manufactured by Tokyo Chemical Industry Co., Ltd.).

The 5% weight loss temperature (Td₅%) of the obtained target compound was 341.4° C., and the melting point was 285.8° C.

### Synthesis Example 12

### Production of N¹,N⁵-diphenylnaphthalene-1,5-dicarboxamide

A target compound (compound L) in a white powder form was obtained by the same operation as in Synthesis Example 1 except that the amount of aniline was changed to 0.81 g (8.7 mmol), the amount of triethylamine was changed to 0.80 g (7.9 mmol), and terephthaloyl chloride was changed to 1.00 g (4.0 mmol) of naphthalene-1,5-dicarbonyl dichloride (manufactured by Tokyo Chemical Industry Co., Ltd.).

The 5% weight loss temperature (Td₅%) of the obtained target compound was 360.8° C., and the melting point was 350.4° C.

### Synthesis Example 13

### Production of N¹,N⁶-diphenyladipamide

A target compound (compound M) in a white powder form was obtained by the same operation as in Synthesis Example 1 except that the amount of aniline was changed to 1.12 g (12 mmol), the amount of triethylamine was changed to 1.10 g (11 mmol), and terephthaloyl chloride was changed to 1.00 g (5.5 mmol) of adipoyl dichloride (manufactured by Tokyo Chemical Industry Co., Ltd.).

The 5% weight loss temperature (Td₅%) of the obtained target compound was 313.1° C., and the melting point was 243.9° C.

### Synthesis Example 14

### Production of N,N′-(1,4-phenylene)dibenzamide

A target compound (compound N) in a white powder form was obtained by the same operation as in Synthesis Example 1 except that aniline was changed to 0.42 g (3.6 mmol) of 1,4-phenylenediamine (manufactured by Tokyo Chemical Industry Co., Ltd.), the amount of triethylamine was changed to 0.72 g (7.1 mmol), and terephthaloyl chloride was changed to 1.00 g (7.1 mmol) of benzoyl chloride (manufactured by Tokyo Chemical Industry Co., Ltd.).

The 5% weight loss temperature (Td₅%) of the obtained target compound was 325.2° C., and the melting point was 343.9° C.

### Synthesis Example 15

### Production of N,N′-(cyclohexan-1,4-diyl)dibenzamide

A target compound (compound 0) in a white powder form was obtained by the same operation as in Synthesis Example 1 except that aniline was changed to 0.42 g (3.6 mmol) of trans-1,4-cyclohexanediamine (manufactured by Tokyo Chemical Industry Co., Ltd.), the amount of triethylamine was changed to 0.72 g (7.1 mmol), and terephthaloyl chloride was changed to 1.00 g (7.1 mmol) of benzoyl chloride (manufactured by Tokyo Chemical Industry Co., Ltd.).

The 5% weight loss temperature (Td₅%) of the obtained target compound was 329.1° C., and the melting point was 346.0° C.

### Synthesis Example 16

### Production of N,N′-(cyclohexan-1,4-diyl)dicyclohexane carboxamide

A target compound (compound P) in a white powder form was obtained by the same operation as in Synthesis Example 1 except that aniline was changed to 0.39 g (3.4 mmol) of trans-1,4-cyclohexanediamine (manufactured by Tokyo Chemical Industry Co., Ltd.), the amount of triethylamine was changed to 0.69 g (6.8 mmol), and terephthaloyl chloride was changed to 1.00 g (6.8 mmol) of cyclohexanecarbonyl chloride (manufactured by Tokyo Chemical Industry Co., Ltd.).

The 5% weight loss temperature (Td₅%) of the obtained target compound was 316.4° C., and the melting point was 292.6° C.

### Synthesis Example 17

### Production of N¹,N³,N⁵-triphenylbenzene-1,3,5-tricarboxamide

A target compound (compound Q) in a white powder form was obtained by the same operation as in Synthesis Example 1 except that the amount of aniline was changed to 1.16 g (12 mmol), the amount of triethylamine was changed to 1.14 g (11 mmol), and terephthaloyl chloride was changed to 1.00 g (3.8 mmol) of benzene-1,3,5-tricarbonyl chloride (manufactured by Volant Fine Chemical Co., Ltd.).

The 5% weight loss temperature (Td₅%) of the obtained target compound was 349.7° C., and the melting point was 315.3° C.

### Examples 1 to 16

A PGA resin (Kuredux (registered trademark) manufactured by KUREHA CORPORATION) was heated and melted in a hot press at 270° C., and quenched with iced water. The resin was dried under reduced pressure at room temperature for 6 hours to obtain a film-shaped amorphous PGA resin.

To a solution in which 100 parts by mass of the amorphous PGA resin was dissolved in 3,000 parts by mass of 1,1,1,3,3,3-hexafluoro-2-propanol (HFIPA), 1 part by mass of each of the compounds A to P obtained in Synthesis Examples 1 to 16 was added as a crystal nucleator, and the mixture was stirred at room temperature (about 25° C.) for 30 minutes, to obtain an uniform dispersion liquid. HFIPA in the dispersion liquid was distilled off using an evaporator, to obtain a PGA resin composition containing the crystal nucleator.

About 1 mg of the obtained PGA resin composition was cut out, and the cooling crystallization temperature Tcc was evaluated by DSC. In the evaluation, when the temperature was increased to 270° C. at a temperature increasing rate of 100° C./min, held for 2 minutes, and cooled at a cooling rate of 20° C./min, a temperature at a top of exothermic peak derived from crystallization of the PGA resin observed at that time was measured as Tcc. As the value Tcc is higher, the crystallization rate under the same conditions is higher. This shows that the crystal nucleator has excellent effects. The results are also shown in Table 1.

### Comparative Example 1

Operation and evaluation were carried out in the same manner as in Example 1 except that a crystal nucleator was not added. The result is also shown in Table 1.

### Comparative Example 2

Operation and evaluation were carried out in the same manner as in Example 1 except that the compound Q obtained in Synthesis Example 17 was used as a crystal nucleator. The result is also shown in Table 1.

### Comparative Example 3

Operation and evaluation were carried out in the same manner as in Example 1 except that hydroxylapatite (nano-SHAp MHS-00405 manufactured by SofSera Corporation, average particle diameter: 40 nm) was used as a crystal nucleator. The result is also shown in Table 1.

TABLE 1

| | Crystal nucleator | Tcc[° C.] |
|---|---|---|
| Example 1 | Compound A | 172.1 |
| | N¹,N⁴-diphenylterephthalamide | |
| Example 2 | Compound B | 171.2 |
| | N¹,N⁴-di-p-tolylterephthalamide | |
| Example 3 | Compound C | 167.1 |
| | N¹,N⁴-bis(4-tert-butylphenyl)terephthalamide | |
| Example 4 | Compound D | 147.9 |
| | N¹,N⁴-bis(2-acetylphenyl)terephthalamide | |
| Example 5 | Compound E | 165.4 |
| | N¹,N⁴-bis(3-acetylphenyl)terephthalamide | |
| Example 6 | Compound F | 183.2 |
| | N¹,N⁴-bis(4-acetylphenyl)terephthalamide | |
| Example 7 | Compound G | 170.8 |
| | N¹,N⁴-bis(4-acetamidophenyl)terephthalamide | |
| Example 8 | Compound H | 173.6 |
| | N¹,N⁴-bis(4-hydroxyphenyl)terephthalamide | |
| Example 9 | Compound I | 171.9 |
| | N¹,N⁴-bis(4-methoxyphenyl)terephthalamide | |
| Example 10 | Compound J | 171.5 |
| | N¹,N⁴-dicyclohexylterephthalamide | |
| Example 11 | Compound K | 148.9 |
| | N¹,N³-bis(4-acetylphenyl)isophthalamide | |
| Example 12 | Compound L | 151.5 |
| | N¹,N⁵-diphenylnaphthalene-l,5-dicarboxamide | |
| Example 13 | Compound M | 147.9 |
| | N¹,N⁶-diphenyladipamide | |
| Example 14 | Compound N | 166.4 |
| | N,N′-(1,4-phenylene)dibenzamide | |
| Example 15 | Compound O | 180.9 |
| | N,N′-(cyclohexan-1,4-diyl)dibenzamide | |
| Example 16 | Compound P | 181.6 |
| | N,N′-(cyclohexan-1,4- | |
| | diyl)dicyclohexanecarboxamide | |
| Comparative | None | 144.5 |
| Example 1 | | |
| Comparative | Compound Q | 144.9 |
| Example 2 | N¹,N³,N⁵-triphenybenzene-1,3,5- | |
| | tricarboxamide | |
| Comparative | Hydroxyapatite | 143.2 |
| Example 3 | | |

The results of Table 1 shows that the PGA resin compositions in which a specific carboxylic acid derivative is used as a crystal nucleator (Examples 1 to 16) show high Tcc compared with the PGA resin composition in which a crystal nucleator is not added (Comparative Example 1), the PGA resin composition in which another carboxlic acid derivative is used (Comparative Example 2), and the PGA resin composition in which hydroxyapatite conventionally used is used (Comparative Example 3), and has a crystallization promoting effect. Therefore, when the specific carboxylic acid derivate is added to the PGA resin as the crystal nucleator, the crystallization rate of the PGA resin is enhanced, and a PGA resin composition having excellent heat resistance and molding processability can be provided.

1. A poly(glycolic acid) resin composition comprising a poly(glycolic acid) resin and a crystal nucleator composed of a carboxylic acid derivative of Formula [1]:
B¹-L¹-A-L²-B² [1]
{wherein, A is a C₁₋₆ alkylene group optionally having a substituent, or a divalent C₆₋₁₀ aromatic group optionally having a substituent; B¹ and B² are each independently a C₃₋₆ cycloalkyl group optionally having a substituent, or a C₆₋₁₀ aromatic group optionally having a substituent; L¹ and L² are each independently —C(═O)NR¹— (wherein, R¹ is a hydrogen atom or a C₁₋₆ alkyl group) or —C(═O)O-}.

2. The poly(glycolic acid) resin composition according to claim 1, wherein at least one of L¹ and L² is —C(═O)NR¹— (wherein, R¹ has the same meanings as described above).

3. The poly(glycolic acid) resin composition according to claim 1, wherein L¹ and L² are —C(═O)NR¹— (wherein, R¹ has the same meanings as described above).

4. The poly(glycolic acid) resin composition according to claim 1, wherein A is a divalent organic group of Formula [2] or [3]: 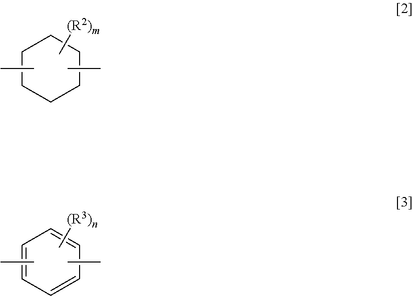
{wherein, R² and R³ are each independently a C₁₋₆ alkyl group, a C₂₋₇ acyl group, a C₂₋₇ alkoxycarbonyl group, an amino group, a C₁₋₆ acylamino group, a hydroxy group, or a C₁₋₆ alkoxy group; m is an integer of 0 to 10 (when m is 2 or more, R²s may be the same or different from each other), n is an integer of 0 to 4 (when n is 2 or more, R³s may be the same or different from each other)}.

5. The poly(glycolic acid) resin composition according to claim 4, wherein A is a cyclohexane-1,4-diyl group.

6. The poly(glycolic acid) resin composition according to claim 4, wherein A is a p-phenylene group.

7. The poly(glycolic acid) resin composition according to claim 1, wherein B¹ and B² are a monovalent organic group of Formula [4] or [5]: 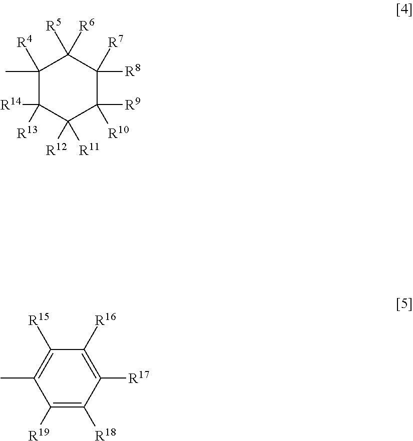
(wherein, R⁴ to R¹⁹ are each independently a hydrogen atom, a C₁₋₆ alkyl group, a C₂₋₇ acyl group, a C₂₋₇ alkoxycarbonyl group, an amino group, a C₁₋₆ acylamino group, a hydroxy group, or a C₁₋₆ alkoxy group).

8. The poly(glycolic acid) resin composition according to claim 7, wherein B¹ and B² are a cyclohexyl group or a monovalent organic group of Formula [6]: 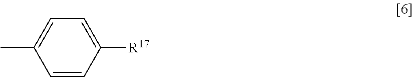
(wherein, R¹⁷ has the same meanings as described above).

9. The poly(glycolic acid) resin composition according to claim 1, wherein a content of the crystal nucleator is 0.001 to 10 parts by mass relative to 100 parts by mass of the poly(glycolic acid) resin.

10. A poly(glycolic acid) resin molded body obtained by crystallizing the poly(glycolic acid) resin composition according to claim 1.

11. A laminate having a layer of the poly(glycolic acid) resin molded body according to claim 10.
